(19) United States
(12) Patent Application Publication
(10) Pub. No.: US 2025/0119040 A1
(43) Pub. Date: Apr. 10, 2025

(54) ASSEMBLY OF A ROTOR OF A GENERATOR OF A WIND TURBINE

(71) Applicant: SIEMENS GAMESA RENEWABLE ENERGY A/S, Brande (DK)

(72) Inventors: Marius Fuerst-Sylvester, Cuxhaven (DE); Benjamin Henriksen, Herning (DK); Thorsten Schneider, Bremervörde (DE); Martin Bach Soerensen, Herning (DK)

(21) Appl. No.: 18/833,216

(22) PCT Filed: Mar. 16, 2023
(86) PCT No.: PCT/EP2023/056754

§ 371 Date: Jul. 25, 2024

(30) Foreign Application Priority Data
Mar. 16, 2022 (EP) 22162426.5

(51) Int. Cl. H02K 15/16; H02K 7/18; H02K 15/03; H02K 15/90

(52) U.S. Cl. CPC H02K 15/16; H02K 15/03; H02K 15/90; H02K 7/183

(57) ABSTRACT

It is described a method of aiding an assembly process of a rotor (30) of an electrical generator (10), in particular permanent magnet electrical generator, in particular of a wind turbine, the method comprising: arranging a rotor house (31) and a rotor bearing (32) at a static relative position; arranging an optical measurement device (140) at a static position relative to the rotor house (31) and the rotor bearing (32); measuring, using the optical measurement device (140), plural first distances (d1a, d1b, . . . ) between the optical measurement device (140) and plural first measurement locations (11a, 11b, . . . ) at the rotor house (31); determining at least one center point (zh) of the rotor house at at least one axial position or an axis (Z) of the rotor house (31) based on the plural first distances (d1a, d1b, . . . ); measuring, using the optical measurement device (140), plural second distances (d2a, d2b, . . . ) between the optical measurement device (140) and plural second measurement locations (12a, 12b, . . . ) at the rotor bearing (32); determining at least one center point (zb) of the rotor bearing (32) at at least one axial position based on the plural second distances (d2a, d2b, . . . ); changing (dv) the relative positioning of the rotor house (31) and the rotor bearing (32) in dependence of the determined center points (zb, zh) or the rotor house axis (Z) and the center point (zb) of the rotor bearing.

### FIELD OF THE INVENTION

The present invention relates to a method of aiding an assembly process of a rotor of an electrical generator, relates to a method of assembling a rotor of an electrical generator and further relates to an arrangement for aiding an assembly process of a rotor of an electrical generator as well as to an arrangement for assembling a rotor of an electrical generator.

Further, the invention relates to a method and an arrangement for measuring the position of a plurality of points in a rotor of an electrical generator. The invention further relates to a method for assembling a rotor for an electrical generator. Particularly, but not exclusively, the invention can be applied to an electrical generator for a wind turbine. More particularly, but not exclusively, the invention can be applied to a permanent magnet electrical generator.

### ART BACKGROUND

A rotor of an electrical generator may comprise several components, such as a rotor house and a rotor bearing. The rotor bearing enables to rotatably support the assembled rotor to a stator of the electrical generator. Before coupling the rotor bearing with the rotor house, the respective symmetry axes or center points must be aligned to each other.

In conventional assembly methods, misalignments of the different components of the rotors were observed to occur resulting in a deficient assembled rotor.

Thus, there may be a need for a method of aiding an assembly process, there may be a need for a method of assembling a rotor and there may be respective needs for respective arrangements for aiding an assembly process of a rotor of an electrical generator or for assembling a rotor of an electrical generator, wherein misalignments of different components of the rotors may be reduced or even avoided.

The airgap, which is formed between the stator and a rotor in a wind turbine electrical generator is an important design feature that contributes to the overall efficiency of the wind turbine. The tighter the airgap is and the less it fluctuates over the lateral surfaces at the axial ends of the stator and the rotor, the more energy can be generated and the higher the efficiency is. Fluctuations of the airgap are in particular influenced by the eccentricity of the coupling between the stator and the rotor of the electrical generator. The overall eccentricity is determined by the shape of the rotor house and of the bearing assembly, by the different radial extensions of the magnets and by the misalignment between the axes of the rotor and the stator.

It is therefore desirable to provide a method and an arrangement for measuring the shape in a rotor an electrical generator for a wind turbine. It is further desirable to provide a method for assembling an electrical generator, which minimizes the eccentricity of the coupling between the stator and the rotor.

### SUMMARY OF THE INVENTION

This need may be met by the subject matter according to the independent claims. Advantageous embodiments of the present invention are described by the dependent claims.

According to an embodiment of the present invention it is provided a method of aiding an assembly process of a rotor of an electrical generator, in particular permanent magnet electrical generator, in particular of a wind turbine, the method comprising: arranging a rotor house and a rotor bearing at a static relative position; arranging an optical measurement device at a static position relative to the rotor house and the rotor bearing; measuring, using the optical measurement device, plural first distances between the optical measurement device and plural first measurement locations at the rotor house; determining at least one center point of the rotor house at at least one axial position or an axis of the rotor house based on the plural first distances; measuring, using the optical measurement device, plural second distances between the optical measurement device and plural second measurement locations at the rotor bearing; determining at least one center point of the rotor bearing at at least one axial position based on the plural second distances; changing the relative positioning of the rotor house and the rotor bearing in dependence of the determined center points or the rotor house axis and the center point of the rotor bearing.

The rotor house as well as the rotor bearing may have substantially cylindrical shape having a respective symmetry axes. The rotor house may for example have a diameter between 5 m and 10 m.

The rotor house may have, at its inner limitation or surface plural magnet module tracks or rails enabling to insert (in particular along an axial direction) plural magnet modules. During performing the method of assembling or of aiding an assembly process of a rotor or during assembling the rotor, the rotor house may be void of any magnet modules inserted. Insertion of the magnet modules may be performed after the rotor house has been mounted or coupled to the rotor bearing which may in particular be performed if the respective symmetry axes or center points of the rotor house and the rotor bearing deviate less than a threshold value.

The rotor bearing may for example have a smaller diameter than the rotor house. The diameter of the rotor bearing may for example amount to between 2 m and 5 m.

Before starting the optical measurements, the rotor house and the rotor bearing have been arranged at respective positions, such that a particular static relative positioning is achieved. The relative position may for example be characterized by a one or more vectors between pairs of first measurement locations and second measurement locations. During the optical measurements, the static relative position of the rotor house and the rotor bearing is not changed and remains unchanged. For the measurements, the rotor house and the rotor bearing not necessarily need to be coupled or connected to each other. They may for example be supported by respective support equipment as will be explained below.

The optical measurement device may also be supported by respective support equipment such that the optical device not necessarily is connected or coupled to any of the rotor house or the rotor bearing. In other embodiments, the optical measurement device may be coupled to anyone or both of the rotor house and the rotor bearing.

The optical measurement device may be configured to direct a light beam, in particular laser beam, to any of the first measurement locations and the second measurement locations. The optical measurement device may be configured to determine distances by evaluating reflected light being reflected due to impingement of the light beam towards the first measurement locations and the second measurement locations. In order to direct the light beam towards the different measurement locations, the optical measurement device may comprise a deflecting element which may be movable, in particular rotatable. The optical measurement device and/or a processor or processing module may process the plural distance measurement values and determine the center point of the rotor house at at least one axial position based on processing the plural first distances. Thereby, the processing module or the optical measurement device may for example perform fitting including a least square procedure.

The axis of the rotor house may correspond to a cylinder symmetry axis of the rotor house or at least to an approximate cylinder symmetry axis of the rotor house. The plural first measurement locations at the rotor house may be or may correspond to predetermined surface portions comprised in the rotor house or may be formed by auxiliary measurement members which may be attached or coupled to predetermined surface areas at the rotor house. The plural first measurement locations and/or the respective surface areas of the rotor house may have been previously determined or selected such that measuring their respective distances to the measurement device enables appropriate characterization of the rotor house regarding its geometry, in particular regarding its center point at at least one axial position and/or its axis. The same may hold for the second measurement locations at the rotor bearing.

For one axial position, for example between 10 and 100, first measurement locations may have been selected or defined and which are then measured using the optical measurement device. Further, between 10 and 100 second measurement locations may have been selected and may then be measured using the measurement device.

If the determined center point(s) of the rotor house and the center point of the rotor bearing essentially match or being offset by less than a threshold value, changing the relative positioning of the rotor house and the rotor bearing may not be performed and may not be necessary.

According to an embodiment of the present invention, the relative positioning of the rotor house and the rotor bearing is only changed, if the respective center points of the rotor house and the center point of the rotor bearing are offset or deviate more than a threshold value. The axis of the rotor house may for example be determined as a line essentially connecting center points of the rotor house being determined for different axial positions. Therefore, for determining the rotor house axis, a regression algorithm or fitting algorithm may be performed. By performing the method, misalignment between the rotor house and the rotor bearing may be reduced.

According to an embodiment of the present invention, during the measuring the optical measurement device has fixed position relative to the rotor house and the rotor bearing.

The optical measurement device may at least be at a fixed position when a set of measurement with respect to first measurement locations which are at the same axial position is performed. For the same fixed position of the measurement device also at least one set of measurements of the first or second measurement locations may be performed which are at substantially the same axial position. For measuring first measurement locations and/or second measurement locations at a different axial position, the optical measurement device may be changed in its position but may preferably be remaining at an unchanged position. Thereby, the measurement process may be simplified.

According to an embodiment of the present invention, during the measuring a stiffening ring, in particular brake disk, is mounted at the rotor house.

The stiffening ring may for example be mounted at a front face (at one axial end) or at one (axial) side of the rotor house. The stiffening ring may enforce the stability of the rotor house in order to reduce possible deformation. According to an embodiment, any stiffening ring is not mounted at the rotor house during the optical measurements. In the assemble rotor, the stiffening ring may be mounted at the rotor house. Thereby, flexibility of the method may be improved. Further, if the stiffening ring is mounted at the rotor house, the rotor house may assume a shape for the measurement process as in the final assembled state. Thus, the measurement values may represent to a better degree the measurement values which would be obtained at or when the completely assembled rotor is examined.

According to an embodiment of the present invention, the first and/or the second measurement locations are spaced apart in a circumferential direction and cover substantially a whole circumference.

The first and/or second measurement locations may for example be spaced apart in the circumferential direction between 10° and 30° or 60° for example. When the first and/or the second measurement locations cover substantially a whole circumference, the respective center points or axes may be determined in a more reliable and more accurate manner.

According to an embodiment of the present invention, subsets of the first and/or second measurement locations are substantially at a same axial position with respect to an axial direction, different subsets being at different axial positions, in particular including axial end positions.

The axial direction may run substantially parallel to a cylinder symmetry axis. When different axial positions or when measurement locations at different axial positions are measured, the rotor house axis may be determined in a more reliable and accurate manner.

According to an embodiment of the present invention, the plural first measurement locations at the rotor house are at two to ten different axial positions. Thereby, a good compromise between required measurement time, processing efforts and accuracy of the determined center points or axes may be achieved.

According to an embodiment of the present invention, at least one of the plural first measurement locations at the rotor house is within a mounting and/or contact surface within a track for mounting a permanent magnet module, and/or wherein the rotor is an outer rotor.

In a later assembly step, plural permanent magnet modules may be attached or coupled or inserted at the rotor house such that base plates of the permanent magnet modules contact the contact surface within the track at the rotor house. When exactly the contact surface within the track at the rotor house is measured, the respective appropriate magnet module having an appropriate thickness may be selected, such that the distance between the radially inner magnet module surface (for example a cover covering a permanent magnet) and the rotor house axis may be substantially even or having the same amount across the whole circumference of the rotor house. Thereby, an air gap between the radially inner surface of the respective magnet modules and stator elements, in particular stator teeth or windings may have a substantially same width across the circumference. When the rotor is an outer rotor, in the completely assembled generator, magnet modules may be mounted at the rotor house such that radially inner surfaces of the magnet modules represent the radially inner limitation of the rotor house.

According to an embodiment of the present invention, at least one of the plural second measurement locations at the rotor bearing is at an edge of the bearing.

The edge of the bearing may be a radially inner limiting surface of the rotor bearing. The edge may therefore be easily accessible by a light beam emitted from the measurement device.

The measurement device may e.g. positioned within or inside the rotor house and/or within or inside the rotor bearing.

According to an embodiment of the present invention, the first and/or second measurement locations are formed by auxiliary members including reflection surfaces, the auxiliary members being arranged in known spatial relationships to locations of interest at the rotor house or the rotor bearing, respectively.

The auxiliary members may also be referred to as measurement adapters. The reflection surfaces may improve the reflection properties, such that the impinging light beam is reflected in an improved manner having a relatively high reflection coefficient such that the reflected light intensity is higher compared to the case where a reflection surface is missing. The locations of interest may have been pre-selected or defined in particular being locations of interest at one or more predetermined axial and circumferential positions. Utilizing or employing the auxiliary members may improve sensitivity and thereby also accuracy of the determination of the respective center points or axes.

According to an embodiment of the present invention, arranging the rotor house and the rotor bearing at the static relative position includes one of at least partially mounting the rotor house and a rotor bearing at each other; supporting the rotor house and the rotor bearing with support equipment without connecting/coupling the rotor house and the rotor bearing.

Mounting the rotor house and the rotor bearing at each other may include to connect a portion of the rotor house and a portion of the rotor bearing for example with a bolt or a screw. When the rotor house and/or the rotor bearing is supported by a support equipment, the respective rotor house and/or the rotor bearing may be mounted or coupled to the support equipment, but may not be supported (directly) to each other. Thereby, more flexibility is provided for performing the method.

According to an embodiment of the present invention it is provided a method of assembling a rotor of an electrical generator, the method comprising: performing a method of aiding an assembly process of the rotor according to one of the preceding embodiments iteratively, in particular until the determined rotor house center points or the rotor house axis and the center point of the rotor bearing are radially and/or circumferentially offset less than a threshold; coupling the rotor house and the rotor bearing to each other without changing the relative position; inserting, in particular axially, magnet modules, in particular in tracks, at the rotor house, the magnet modules in particular having different thickness, the inserting being performed in dependence of the plural first distances or distances between the rotor house axis and the plural first measurement locations; optionally coupling a stiffening ring, in particular configured as brake disk, to the rotor house.

The aiding method may not actually include to assemble the rotor but may be considered as an intermediate or previous step of assembling the rotor of the electrical generator. The aiding method may be considered as a method to achieve or reach a desired alignment of the rotor bearing relative to the rotor house. The aiding method may be iteratively performed in the direction to decrease any respective deviation between a respective center point(s) of the rotor house and the center point of the rotor bearing or in order to deviate any present (non-axial) deviation from a rotor house axis and a rotor bearing center point.

The radial direction and the circumferential direction are directions both being perpendicular to the axial direction.

The thickness of the magnet modules may be considered as a radial extent of the respective magnet modules when inserted into the tracks at the rotor house. For example, a first magnet module having a first thickness may be inserted at a track which comprises a first measurement location which has a first distance to the determined symmetry axis of the rotor house. Another first module having a another first thickness may be inserted into a track comprising another first measurement location having another first distance to the determined symmetry axis of the rotor house. Thereby, a first difference between the first distance and the first thickness may be closer to (or substantially equal to) a second difference between the other first distance and the other first thickness than if the magnet would have been inserted in a exchanged manner.

It should be understood, that features, individually or in any combination, disclosed, explained, provided or employed for a method of aiding an assembly process of a rotor of an electrical machine or which have been provided, explained or employed for a method of assembling a rotor of an electrical generator, may, individually or in any combination, also applied or employed for an arrangement for aiding an assembly process or for assembling a rotor of an electrical generator, according to embodiments of the present invention and vice versa.

According to an embodiment of the present invention it is provided an arrangement for aiding an assembly process and/or for assembling of a rotor of an electrical generator, the arrangement comprising: support equipment adapted to arrange a rotor house and a rotor bearing at a static relative position; an optical measurement device arrangeable at a static position relative to the rotor house and the rotor bearing and being adapted: to measure plural first distances between the optical measurement device and plural first measurement locations at the rotor house; to measure plural second distances between the optical measurement device and plural second measurement locations at the rotor bearing; a processor adapted: to determine at least one center point of the rotor house at at least one axial position or an axis of the rotor house based on the plural first distances; to determine at least one center point of the rotor bearing at at least one axial position based on the plural second distances, wherein the support equipment is further adapted to change the relative positioning of the rotor house and the rotor bearing in dependence of the determined center points or the rotor house axis and the center point of the rotor bearing.

The arrangement may be utilized in order to perform a method of aiding an assembly process of a rotor of an electrical generator according to an embodiment of the present invention.

The support equipment may for example comprise a frame to statically support the rotor house (against gravity). Support equipment may further comprise one or more support members which support (e.g. against gravity) the rotor bearing but which may also allow to laterally move the rotor bearing in the radial and/or circumferential direction. Thereby, the alignment or the changing the relative positioning of the rotor house and the rotor bearing may be achieved. The support equipment may also comprise driving members and/or actuators which enable to change at least the relative positioning of the rotor house and the rotor bearing, in particular by moving the rotor bearing in the radial and/or circumferential direction and/or also in the axial direction for axial alignment.

According to an embodiment of the present invention, the optical measurement device comprises at least one of: a laser configured to emit a laser beam; a deflector, in particular including a mirror, rotatable around at least one axis, in particular rotatable around two axes that are perpendicular to each other, the deflector being arranged to deflect the laser beam towards the plural first measurement locations and the plural second measurement locations; a scan drive system to rotate the deflector; a detector to detect a laser beam reflected from the plural first measurement locations or plural second measurement locations in a time resolved manner; a processor configured to determine a distance between the optical measurement device (5) and at least one of the first locations or second measurement locations based on time-of-flight determination and/or frequency shift determination of the reflected laser beam versus the emitted laser beam, the processor being configured to determine a position of the measurement location based on the associated distance and angle setting of the deflector.

Thereby conventionally available components may be utilized to implement the device.

According to an embodiment of the present invention, the optical measurement device comprises a laser device, in particular a light detection and ranging device (LIDAR).

According to a first aspect of the present invention it is provided a method for measuring the position of a plurality of points in a rotor of an electrical machine, the rotor including a rotor house, a rotor bearing and a brake disc, the method including the steps of:
forming an assembly including the rotor house, the rotor bearing and the brake disc,
mounting a measurement device inside the assembly,
relatively moving the rotor and the measurement device and determining a plurality of distances between an axis of the rotor house and the plurality of points.

The method may partly be implemented in software and/or hardware. The electrical machine may be an electrical generator or an electrical motor. In particular, the electrical machine may be an electrical generator of a wind turbine.

Measuring a plurality of points in a rotor of an electrical machine helps in defining the shape of the rotor or the eccentricity of the rotor one the rotor is coupled to the stator of the electrical machine. This may be used for conveniently coupling a plurality of magnets in the plurality of seats, so that the thickness of the air gap between the rotor and the stator is kept constant and as close as possible to a minimum desired value.

In a second aspect of the invention, an assembly method for assembling a rotor of an electrical machine is provided. The method includes the steps of:
defining a plurality of points on the rotor house to be measured as described above,
defining an optimum position for the axis of the rotor bearing so that a variability parameter of a plurality of distances between said optimum position and the plurality of points on the rotor house is minimized,
changing the position of the rotor bearing with respect to the rotor house, so that the distance between the axis of the rotor bearing and the optimum position is minimized.

The assembly method according to the present invention minimizes the eccentricity of the rotor when coupled to the stator.

According to embodiments of the present invention, the variability parameter may be any of:
a difference between a maximum and a minimum value of said plurality of distances,
a standard deviation of said plurality of distances.

According to embodiments of the present invention, at least a portion of the plurality of points to be measured are defined on the rotor bearing. At least another portion of the plurality of points to be measured are defined on an inside of the rotor house. Two pluralities of points may be measured, the two pluralities of points being respectively defined on respective planes at two respective axial ends of the rotor house or respectively close thereto. A third plurality of points may be measured, the third plurality of points being axially intermediate between the two axial ends of the rotor house.

According to a third aspect the present invention it is provided a measurement arrangement for measuring the position of a plurality of points in a rotor of an electrical machine, the rotor including a rotor house and a rotor bearing, the arrangement including:
a supporting structure for receiving an assembly including the rotor house, the rotor bearing and the brake disc,
a measurement device movable with respect to the supporting structure for measuring a plurality of distances between an axis of the rotor house and the plurality of points.

According to embodiments of the present invention, wherein the measurement device is an optic device, particularly it may be laser device. The measurement device may be a light detection and ranging device.

It should be understood, that features, individually or in any combination, disclosed, described, explained or provided for a method for measuring the position of a plurality of points in a rotor of an electrical machine are also, individually or in any combination, applicable to a measurement arrangement for measuring the position of a plurality of points in a rotor of an electrical machine according to embodiments of the present invention and vice versa.

The following embodiments according to the following numbered clauses are provided:
1. A method for measuring the position of a plurality of points (111, 112, 113, 114, 115) in a rotor (30) of an electrical machine (10), the rotor (30) including a rotor house (31), a rotor bearing (32) and a brake disc (33), the method including the steps of:
   forming an assembly (35) including the rotor house (31), the rotor bearing (32) and the brake disc (33),
   mounting a measurement device (140) inside the assembly (35),
   relatively moving the rotor (30) and the measurement device (40) and determining a plurality of distances between an axis of the rotor house (31) and the plurality of points (111, 112, 113, 114, 115).
2. The method according to clause 1, wherein at least a portion of the plurality of points are defined on the rotor bearing (32).
3. The method according to clause 1 or 2, wherein at least a portion of the plurality of points are defined on an inside of the rotor house (31).
4. The method according to clause 3, wherein two pluralities of points are measured, the two pluralities of points being respectively defined at two respective axial ends of the rotor house (31).
5. The method according to clause 4, wherein at least a third plurality of points is measured, the third plurality of points being axially intermediate between the two axial ends of the rotor house (31).
6. The method according to any of the clauses 3 to 5, wherein the points to be measured on the rotor house (31) are defined on a plurality of seats (41) for receiving a plurality of permanent magnets.
7. An assembly method for assembling a rotor (30) of an electrical machine (10), the rotor (30) including a rotor house (31) and a rotor bearing (32), the method including the steps of:
   defining a plurality of points on the rotor house (31) to be measured according to any of the claims 3 to 6,
   defining an optimum position for the axis of the rotor bearing (32) so that a variability parameter of a plurality of distances (Di) between said optimum position and the plurality of points on the rotor house (31) is minimized,
   changing the position of the rotor bearing (32) with respect to the rotor house (31), so that the distance between the axis of the rotor bearing (32) and the optimum position is minimized.
8. An assembly method according to clause 7, wherein the variability parameter is any of:
   a difference between a maximum and a minimum value of said plurality of distances,
   a standard deviation of said plurality of distances.
9. A measurement arrangement (100) for measuring the position of a plurality of points (111, 112, 113, 114, 115) in a rotor (30) of an electrical machine (10) for a wind turbine (1), the rotor (30) including a rotor house (31) and a rotor bearing (32), the arrangement including:
   a supporting structure (101) for receiving an assembly (35) including the rotor house (31), the rotor bearing (32) and the brake disc (33),
   a measurement device (140) movable with respect to the supporting structure (101) for measuring a plurality of distances between an axis of the rotor bearing (32) and the plurality of points.
10. The measurement arrangement according to the previous claim, wherein the measurement device (140) is an optic device.
11. The measurement arrangement according to clause 10, wherein the measurement device (140) is a laser device.
12. The measurement arrangement according to clause 11, wherein the measurement device (140) is light detection and ranging device.

The aspects defined above, and further aspects of the present invention are apparent from the examples of embodiment to be described hereinafter and are explained with reference to the examples of embodiment. The invention will be described in more detail hereinafter with reference to examples of embodiment but to which the invention is not limited.

### BRIEF DESCRIPTION OF THE DRAWINGS

FIG. 1 schematically illustrates a wind turbine 1 including an electrical generator which is assembled according to an embodiment of the present invention.

FIG. 2 shows a schematic section of an electrical generator to be mounted on the wind turbine of FIG. 1.

FIG. 3 shows an exploded view of an electrical generator to be mounted on the wind turbine of FIG. 1.

FIG. 4 shows a partial view of a rotor for the electrical generator of FIG. 2 including a brake disc.

FIG. 5 shows another view of the rotor of FIG. 4, where a plurality of measurement points are represented, which are measured with a measurement method according to the present invention.

FIG. 6 shows a measurement device which is usable for performing the measurement method according to the present invention.

FIG. 7 shows results of the measurement method according to the present invention.

FIG. 8 shows a step of an assembly method for assembling a rotor for an electrical generator according to the present invention.

### DETAILED DESCRIPTION

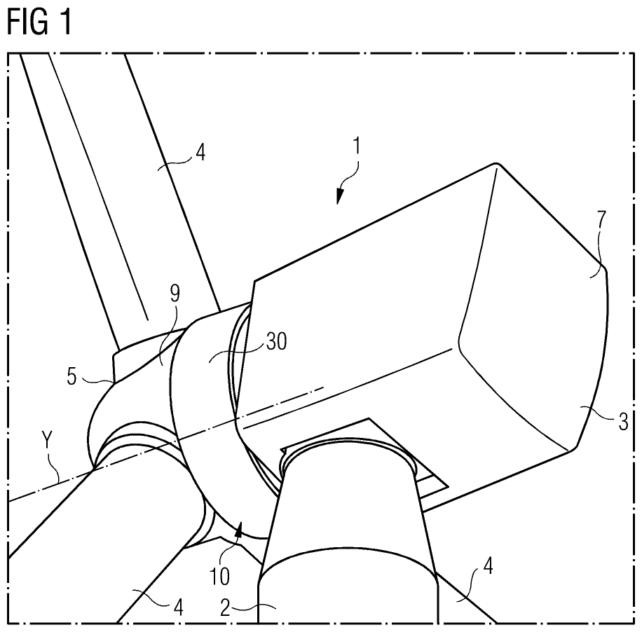

FIG. 1 shows a wind turbine 1 according to the invention. The wind turbine 1 comprises a tower 2, which is mounted on a non-depicted foundation. A nacelle 3 is arranged on top of the tower 2. The nacelle 3 comprises a main frame 7 rotatably coupled with the tower 2, an electrical generator 10 rotatably coupled with the main frame 7 and an hub 9 fixed to a rotor 30 of the electrical generator 10. The wind turbine 1 further comprises a wind rotor 5 including the hub 9 and at least one blade 4 fixed to the hub 9 (in the embodiment of FIG. 1, the wind rotor comprises three blades 4. The wind rotor 5 is rotatable around a rotational longitudinal axis Y. The blades 4 extend substantially radially with respect to the longitudinal rotational axis Y. In general, when not differently specified, the terms axial, radial and circumferential in the following are made with reference to the longitudinal rotational axis Y. The electrical generator 10 including the rotor 30 and a stator (not visible in FIG. 1) fixed to the main frame 7 of the nacelle 3. In the embodiment of the attached figures the rotor 30 is radially external to the stator. The rotor 30 is rotatable with respect to the stator about the longitudinal rotational axis Y.

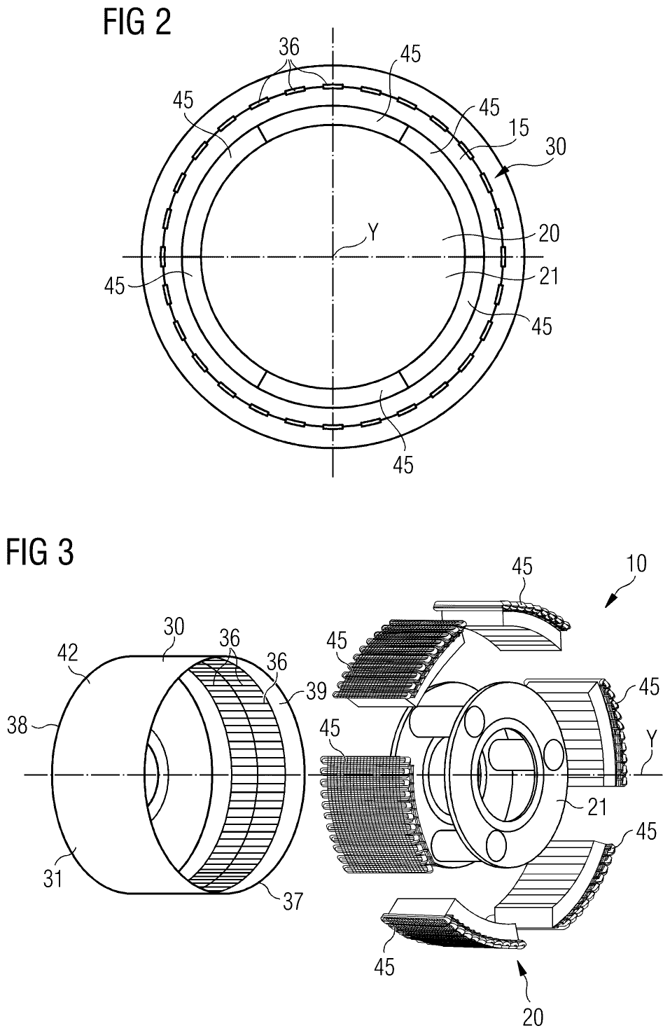

FIG. 2 shows a schematic view of a cross section of the electrical generator 10 on a radial plane orthogonal to the longitudinal rotational axis Y. The electrical generator 10 including the rotor 30 and the stator 20, which is radially internal to the rotor 30. In FIG. 2 the rotor 30 and the stator 20 are ideally represents as two coaxial ideal cylinders. The electrical generator 10 comprises an airgap 15 radially interposed between the stator 20 and the rotor 30, the airgap 15 extending circumferentially about the rotational axis Y. The stator 20 comprises a cylindrical inner core 21 to which six segments 45 are attached. Each segment 45 has a circumferential angular extension of 60°. According to other embodiments of the present invention, the stator 20 comprises a plurality of segments having another number (different from six) of segments. The rotor 30 comprises a plurality of circumferentially distributed permanent magnets 36 facing the airgap 15.

FIG. 3 shows an exploded view of the electrical generator 10 showing axonometric schematic representation of the rotor 30 and the stator 20. The rotor 30 comprises a cylindrical rotor house 31 axially extending between a drive end 37, which is subject to be mounted adjacent to the hub of the wind rotor 5, and an axially opposite non-drive end 38, which is subject to be mounted adjacent to the main frame 7 of the nacelle 3. The rotor house has cylindrical hollow shape radially extending between an inner surface 39, on which a plurality of respective seats for the permanent magnets 36 are defined, and an external surface 42. The magnets 31 are distributed on the inner side 39 of the rotor house 31 according to axial columns. Each column of magnets comprises a plurality of magnets 36 (for example two magnets 36 as shown in FIG. 2) aligned along the rotational axis Y.

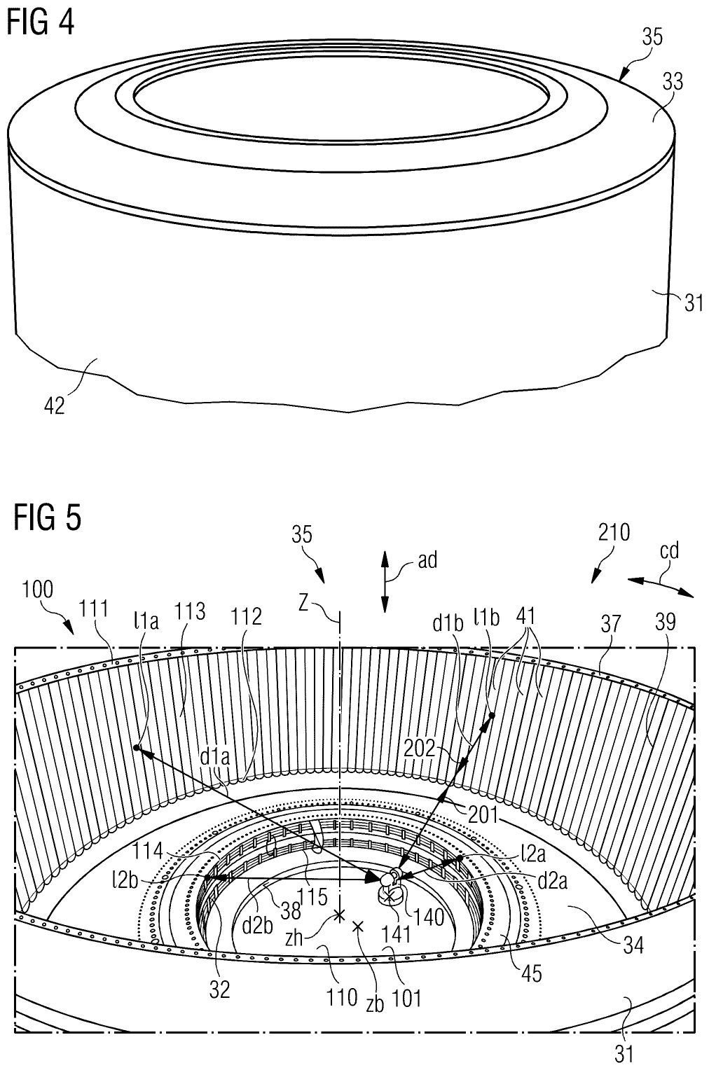

FIG. 4 shows an assembly 35 including components of the rotor 30. The assembly 35 includes the rotor house 31, a brake disc 33 and a rotor bearing 32 (not visible in the view of FIG. 4, where the external surface 42 of the rotor house 31 is shown). The brake disc 33 is provided at the non-drive end 38 and radially extends from the rotor house 31 towards the axis of the rotor house 31. According to embodiments of the present invention, the assembly 35 may not include a brake disc 33.

The brake disk 33 is an example of a stiffening ring according to an embodiment of the present invention. The brake disk (in general a stiffening ring) is mounted at the rotor house, in particular at one side of the rotor house, in particular on an axial side of the rotor house. On the other (axial) side of the rotor house, a rotor bearing 32 (not visible in FIG. 4) may be mounted.

FIG. 5 shows an inside of the assembly 35, where the rotor bearing 32 and the inner surface 39 of the rotor house 31 are visible. The rotor bearing 32 is provided at the non-drive end 38 and in operation is coupled with the stator 20, thus permitting the rotation of the rotor 30 with respect to the longitudinal axis Y of the generator 10. The rotor bearing 32 defines an axis of rotation which is in operation to be ideally aligned to the longitudinal axis Y. The rotor bearing 32 axially extend between the brake disc 33 and an inner rotor plate 34. The inner rotor plate 34 extends radially between the rotor bearing 32 and the inner surface 39, the inner rotor plate 34 being fixed to an inner front surface 46 of the rotor bearing 32. On the inner surface 39 a plurality of axially extending seats 41 for the permanent magnets 36 are defined. FIG. 5 further shows a measurement arrangement 100 for measuring the position of a plurality of points 111, 112, 113, 114, 115 in the assembly 35. The measurement arrangement 100 includes a supporting structure, for example a 101 for receiving and supporting the assembly 35. The measurement arrangement 100 includes a measurement device 140 movable with respect to the supporting structure 101 for measuring a plurality of distances between the axis Z and the plurality of points 111, 112, 113, 114, 115 to be measured. At least a portion of the plurality of points 111, 112, 113, 114, 115 to be measured may be defined on an inside of the rotor house 31, i.e. on the inner surface 39 or along the seats 41 for the permanent magnets 36. A first plurality of points 111 may be defined at the drive end 37. Each of the first plurality of points 111 may be for example defined along a respective seat 41 for the permanent magnets 36. A second plurality of points 112 may be defined at the opposite axial ends of the seat 41, i.e. the axial ends of the seat 41 that are closer to the non-drive end 38. A third plurality of points 113 may be defined along the seat 41 for the permanent magnets 36 at intermediate positions between the first plurality of points 111 and the second plurality of points 112. The third plurality of points 113 may lie on a same plane orthogonal the axis Z. A fourth plurality of points 114 may be defined on the rotor bearing 32, for example along the border of the rotor bearing 32 which is closer to the drive end 37. The fourth plurality of points 114 may be defined also on the inner front surface 46 of the rotor bearing 32. Reflectors may be positioned on the inner front surface 46 to facilitate the measurements by the measurement device 140. A fifth plurality of points 115 along the border of the rotor bearing 32 which is closer to the non-drive end 38.

FIG. 5 schematically illustrates a state during performing a method of an aiding an assembly process of a rotor of a generator according to an embodiment of the present invention. In one (for example a first) step of the method, the rotor house 31 and a rotor bearing 32 are arranged in a static relative position. In another step, an optical measurement device 140 is arranged at a static position 141 (e.g. within the rotor bearing and/or the rotor house) relative to the rotor house 31 and the rotor bearing 32.

In one embodiment, for example the rotor house and the rotor bearing may be supported by a support equipment 101. Also the measurement device 140 may be supported by the support equipment 101 and may optionally also be mounted or fixed at the support equipment 101.

In another step, the optical measurement device 140 is utilized to measure plural first distances d1a, d1b, . . . between the optical measurement device 140 and plural first measurement locations 11a, 11b, 11c, . . . . According to embodiments of the present invention, the points 111, 112, 113 may represent first measurement locations. In another step of the method, at least one center point zh of the rotor house at at least one axial position or an axis Z of the rotor house is determined based on the plural first distances d1a, d1b, . . .

Further, the optical measurement device 140 is utilized to measure plural second distances d2a, d2b, . . . between the optical measurement device 140 and plural second measurement locations 12a, 12b, 12c . . . at the rotor bearing 32. Further, at least one center point zb of the rotor bearing at at least one axial position is determined based on the plural second distances d2a, d2b, . . . . Depending on the determined center points zh, zb or the rotor house axis Z and the center point zb of the rotor bearing, the relative positioning of the rotor house 31 and the rotor bearing 32 is changed.

During performing the measurements, the measurement device 140 remains at a fixed position 141.

The stiffening ring 33 or brake disk may or may not be mounted at the rotor house 31 during the optical measurements.

As can be appreciated from FIG. 5, the first and/or second measurement locations 11a, 11b, . . . , and 12a, 12b, . . . are spaced apart in the circumferential direction cd and cover substantially a whole circumference. According to embodiments of the present invention, the points 114, 115 may serve as second measurement locations.

As can be appreciated from FIG. 5, the first measurement locations 11a, 11b are at a substantially same axial position with respect to the axial direction ad. Other first measurement locations may be at axial ends of the rotor house or at intermediate axial positions between the axial ends of the rotor house. The first measurement locations 11a, 11b, . . . are in particular within a mounting surface or contact surface within a track 41 provided for mounting a not illustrated permanent magnet module.

The rotor house 31 is configured as a rotor house for an outer rotor. FIG. 5 does not illustrate optionally present auxiliary members forming the first and/or the second measurement locations. The auxiliary members may include reflection surfaces for more efficiently reflect a light beam 201 which is emitted by the optical measurement device 140.

During a method of assembling a rotor of an electrical generator, the measurement process and the changing of the relative positioning of the rotor house 31 and the rotor bearing 32 may be performed for example in an iterative manner until a misalignment of the center points zh, zb or the deviation between the rotor house axis Z and the center point zb of the rotor bearing is reduced or smaller than a threshold. If this is the case, the rotor house 31 may be coupled with the bearing 32, for example utilizing plural bolts or screws.

In a next step, plural magnet modules may be inserted along the tracks 41. Thereby, the measurement results may be respected in the sense that magnet modules having different thicknesses are inserted in such a manner to insert the thicker magnet modules in those locations in the tracks which have a relatively larger distance from the symmetry axis Z of the rotor house than other tracks.

The arrangement 210 is an example of an arrangement for aiding an assembly process of a rotor of an electrical generator according to an embodiment of the present invention. The arrangement 210 comprises the support equipment 101 which is adapted to arrange the rotor house 31 and a rotor bearing 32 at a static relative position.

Arrangement 210 further comprises an optical measurement device 140 which is arrangeable at a static position 141 relative to the rotor house 31 and the rotor bearing 32. The optical measurement device 140 is adapted to measure the plural first distances d1a, d1b, . . . between the optical measurement device 140 and plural first measurement locations 11a, 11b, . . . at the rotor house 31. The device 140 is further configured to measure plural second distances d2a, d2b, . . . between the optical measurement device 140 and plural second measurement locations 12a, 12b, . . . at the rotor bearing 32.

A not illustrated processor is further comprised in the arrangement 210 and is adapted to determine at least one center point zh of the rotor house at at least one axial position or an axis Z of the rotor house 31 based on the plural first distances d1a, d1b, . . . The processor is further adapted to determine at least one center point zb of the rotor bearing at at least one axial position based on the plural second distances d2a, d2b, . . .

The support equipment 101 is further configured or adapted to change the relative positioning of the rotor house and the rotor bearing in dependence of the determined center points zh, zb or the rotor house axis Z and the center point zb of the rotor bearing 32.

The measurement device 140 comprises a not in detail illustrated laser configured to emit a laser beam 201 (along a selectable direction). The device 140 further includes a deflector which is rotatable around at least one axis and being arranged to deflect the laser beam 201 towards the plural first measurement locations 11a, 11b, . . . and the plural second measurement locations 12a, 12b, . . . For rotating the deflector, the measurement device comprises a not illustrated scan drive system. The measurement device 140 further comprises a not illustrated detector to detect a laser beam reflected from the plural first measurement locations or the plural second measurement locations 11a, 11b, . . . , 12a, 12b, . . . in a time resolved manner. The reflected laser beam is labelled with reference sign 202 exemplary reflected from the one of the first measurement locations 11a.

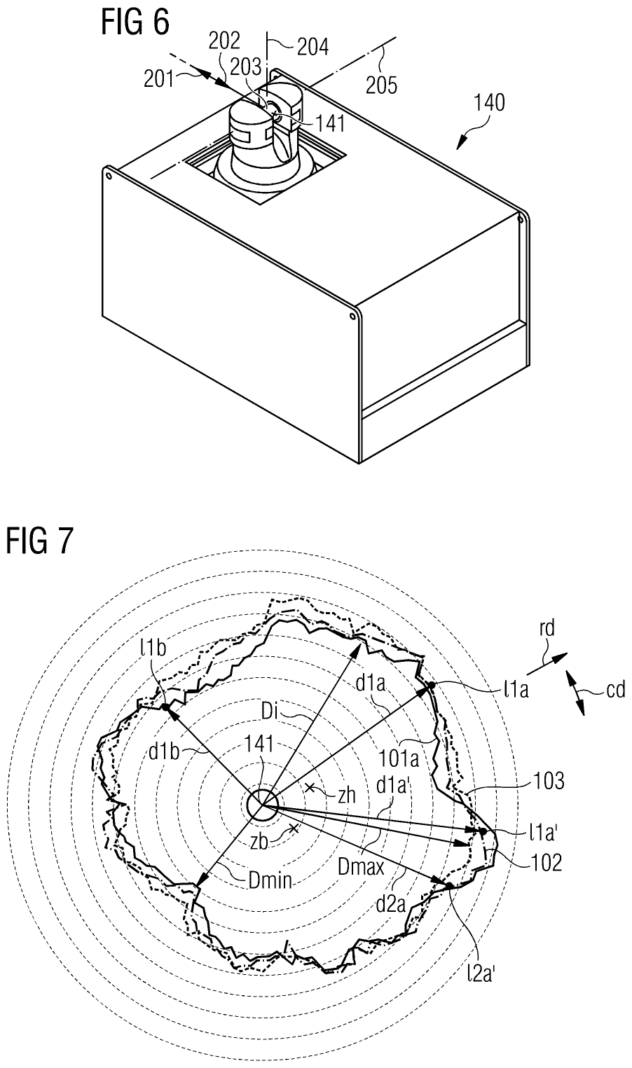

FIG. 6 shows a magnified view of the measurement device 140. The measurement device 140 may be an optic device, in particular a laser device. The measurement device 140 may be a light detection and ranging device.

The measurement device 140 illustrated in FIG. 6 comprises a mirror 203 (at position 141) which is rotatable around two axes 204, 205 which are perpendicular to each other. By rotating the mirror 203 in an appropriate angle setting, the measurement device emits a laser beam 201 in a particular direction such as to impinge to a desired first or second measurement location 11a, 11b, . . . , 12a, 12b, . . . The measurement device receives the reflected beam 202 via the reflector 203 and directs the reflected received beam 202 towards a detector to detect the reflected light in a time resolved manner. An internal processor in the measurement device 140 then determines the respective distance between the measurement device 140 (in particular the mirror 203 and the respective first or second measurement locations). For example, a time-of-flight determination may be performed and/or a frequency shift determination may be performed in order to determine the respective distance.

FIG. 7 shows three curves 101, 102, 103, which graphically represent the positions of the first second and third plurality of points 111, 112, 113 with respect to an axis Z of the rotor house 31 (center point in FIG. 7). At each angular position about the axis Z the radial distance Di of the points of each of the three curves 101, 102, 103 represents the distance of a respective magnet seat 41 from the axis Z. The value of Di varies about the axis Z, spanning from a minimum value Dmin to a maximum value Dmax. The set of measurements Di provides information about the shape of the rotor house 31, i.e. the distance of the plurality of seats 41 from the axis Z. Such information may be used for conveniently coupling a plurality of magnets in the plurality of seats 41, so that the thickness of the air gap 15 is kept constant and as close as possible to a minimum desired value. To such extent a magnet 36 having a maximum radial thickness may be conveniently mounted in the seat 41 corresponding to the maximum value Dmax and a magnet 36 having a minimum radial thickness may be conveniently mounted in the seat 41 corresponding to the minimum value Dmin.

According to other embodiments of the present invention, the curves 101a, 102 are examples of the first distances between the first measurement locations 11a, 11b and the position 141 of the optical measurement device 140 (the position 141 may represent the position of the mirror of the measurement device 140). The distances d1a, d1b represent distances between the measurement device 140 (in particular the position 141 of the mirror 203 of the measurement device 140) and the measurement locations 11a, 11b which are situated at a substantially same axial position. The curve 102 represents the distances d1a′, d1b′ of first measurement locations 11a′, 11b′ which are at another axial position at the rotor house.

The curve 103 may represent the second distances d2a, d2b, . . . between the measurement device 140 and plural second measurement locations 12a, 12b, . . .

Evaluation of the first distances d1a, d1b (curve 101a), d1a′, d1b′ (curve 102), . . . results in the center point zh of the rotor bearing. Evaluation of the plural second distances 12a, 12b, . . . (curve 103) results in the center point zb of the bearing. It is visible from FIG. 7 that the center points of the bearing zb and the center point of the housing zh are laterally offset, i.e. deviate in the radial direction and the circumferential direction. The radial direction is indicated with reference sign rd and the circumferential direction is indicated with reference sign cd in FIG. 7. Depending on the deviation between the center points zb, zh, the rotor house-rotor bearing relative positioning is changed in order to decrease the deviation.

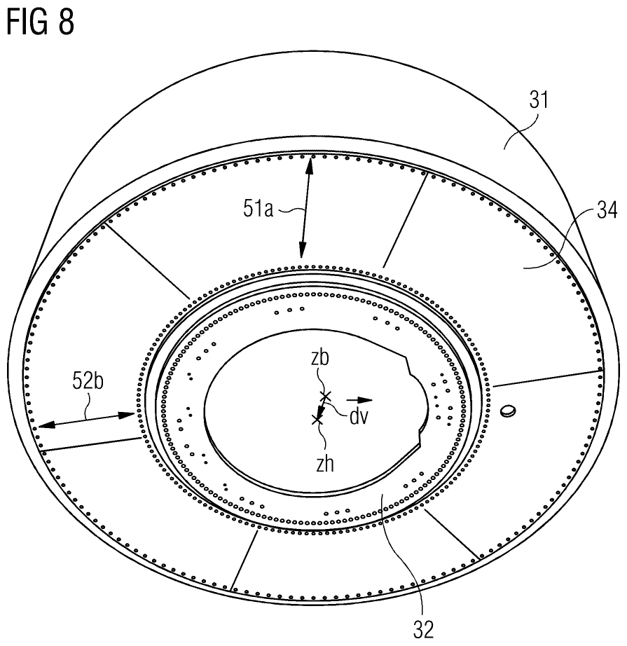

As shown in FIG. 8, the information provided by the set of measurements Di may be used for defining an optimum position of the axis of rotation of the rotor bearing, so that the axis Z is ideally coincident with the rotation axis of the rotor bearing. This minimizes the eccentricity of the rotor 30 when coupled to the stator 20. The optimum position for the axis of rotation of the rotor bearing may be defined as the position in which a variability parameter of a plurality of radial distances Di between said optimum position and the plurality of the measured points 111, 112, 113 on the rotor house 31 is minimized. Any variability parameter may be chosen for defining the optimum position of the axis of rotation of the rotor bearing, for example a difference between a maximum and a minimum value of the plurality of radial distances Di or a standard deviation of the plurality of distances Di. After the optimum position of the axis of rotation of the rotor bearing with respect to the rotor house has been defined, the position of the rotor bearing 32 in the assembly 35 may be changed (as graphically represented by two arrows 52a, 52b in FIG. 8), so that the distance between the axis of rotation of the rotor bearing and such optimum position is minimized or reduced to zero. The above procedure may be used for minimizing the misalignment between the geometric axes of the rotor and the stator. After the new position of the rotor bearing 32 in the assembly 35 is defined, a plurality of magnets may be mounted in the plurality of seats 41.

In FIG. 8, also the determined center point zb of the bearing and the center point zh of the housing are indicated. According to the difference vector dv, the rotor bearing 32 may then be moved such that the center point zb of the rotor bearing 32 coincides or is aligned with the center point zh of the rotor house 31. If this desired positioning is reached, the rotor bearing 32 may be coupled or connected with the rotor house 31.

1. A method of aiding an assembly process of a rotor (30) of an electrical generator (10), in particular permanent magnet electrical generator, in particular of a wind turbine, the method comprising:
arranging a rotor house (31) and a rotor bearing (32) at a static relative position;
arranging an optical measurement device (140) at a static position relative to the rotor house (31) and the rotor bearing (32);
measuring, using the optical measurement device (140), plural first distances (d1a, d1b, . . . ) between the optical measurement device (140) and plural first measurement locations (11a, 11b, . . . ) at the rotor house (31);
determining at least one center point (zh) of the rotor house at at least one axial position or an axis (Z) of the rotor house (31) based on the plural first distances (d1a, d1b, . . . );
measuring, using the optical measurement device (140), plural second distances (d2a, d2b, . . . ) between the optical measurement device (140) and plural second measurement locations (12a, 12b, . . . ) at the rotor bearing (32);
determining at least one center point (zb) of the rotor bearing (32) at at least one axial position based on the plural second distances (d2a, d2b, . . . );
changing (dv) the relative positioning of the rotor house (31) and the rotor bearing (32) in dependence of the determined center points (zb, zh) or the rotor house axis (Z) and the center point (zb) of the rotor bearing.

2. The method according to claim 1, wherein during the measuring the optical measurement device (140) has fixed position (141) relative to the rotor house (31) and the rotor bearing (32).

3. The method according to claim 1, wherein during the measuring a stiffening ring, in particular brake disk (33), is mounted at the rotor house (31).

4. The method according to claim 1, wherein the first and/or the second measurement locations (11a, 11b, 12a, 12b, . . . ) are spaced apart in a circumferential direction (cd) and cover substantially a whole circumference.

5. The method according to claim 1, wherein subsets of the first and/or second measurement locations (11a, 11b, 12a, 12b, . . . ) are substantially at a same axial position with respect to an axial direction, different subsets being at different axial positions, in particular including axial end positions.

6. The method according to claim 1, wherein the plural first measurement locations (11a, 11b, . . . ) at the rotor house are at two to ten different axial positions.

7. The method according to claim 1,
wherein at least one of the plural first measurement locations (11a, 11b, . . . ) at the rotor house is within a mounting/contact surface within a track (41) for mounting a permanent magnet module, and/or
wherein the rotor (30) is an outer rotor.

8. The method according to claim 1, wherein at least one of the plural second measurement locations (12a, 12b, . . . ) at the rotor bearing is at an edge of the bearing (32).

9. The method according to claim 1, wherein the first and/or second measurement locations are formed by auxiliary members including reflection surfaces, the auxiliary members being arranged in known spatial relationships to locations of interest at the rotor house or the rotor bearing, respectively.

10. The method according to claim 1, wherein arranging the rotor house and the rotor bearing at the static relative position includes one of:
at least partially mounting the rotor house (31) and a rotor bearing (32) at each other;
supporting the rotor house (31) and the rotor bearing (32) with support equipment without connecting/coupling the rotor house and the rotor bearing.

11. A method of assembling a rotor of an electrical generator, the method comprising:
performing a method of aiding an assembly process of the rotor according to claim 1 iteratively, in particular until the determined rotor house center points (zh, zb) or the rotor house axis (Z) and the center point (zb) of the rotor bearing are radially and/or circumferentially offset less than a threshold;
coupling the rotor house (31) and the rotor bearing (32) to each other without changing the relative position;
inserting, in particular axially, magnet modules, in particular in tracks, at the rotor house, the magnet modules in particular having different thickness, the inserting being performed in dependence of the plural first distances or distances between the rotor house axis and the plural first measurement locations;
optionally coupling a stiffening ring, in particular configured as brake disk, to the rotor house.

12. An arrangement (210) for aiding an assembly process and/or for assembling of a rotor (30) of an electrical generator, the arrangement comprising:
support equipment (101) adapted to arrange a rotor house (31) and a rotor bearing (32) at a static relative position;
an optical measurement device (140) arrangeable at a static position (141) relative to the rotor house (31) and the rotor bearing (32) and being adapted:
to measure plural first distances (d1a, d1b, . . . ) between the optical measurement device (140) and plural first measurement locations (11a, 11b, . . . ) at the rotor house (31);
to measure plural second distances (d2a, d2b, . . . ) between the optical measurement device (140) and plural second measurement locations (12a, 2b, . . . ) at the rotor bearing (32);
a processor adapted:
to determine at least one center point (zh) of the rotor house (31) at at least one axial position or an axis (Z) of the rotor house (31) based on the plural first distances (11a, 11b, . . . );
to determine at least one center point (zb) of the rotor bearing (32) at at least one axial position based on the plural second distances (12a, 12b, . . . ),
wherein the support equipment (101) is further adapted to change the relative positioning of the rotor house (31) and the rotor bearing (32) in dependence of the determined center points or the rotor house axis and the center point of the rotor bearing.

13. The arrangement according to the claim 1, wherein the optical measurement device (140) comprises at least one of:
a laser configured to emit a laser beam (201);
a deflector (203), in particular including a mirror, rotatable around at least one axis, in particular rotatable around two axes (204, 205) that are perpendicular to each other, the deflector being arranged to deflect the laser beam towards the plural first measurement locations (11a, 11b, . . . ) and the plural second measurement locations (2a, 12b, . . . );
a scan drive system to rotate the deflector (203);
a detector to detect a laser beam reflected from the plural first measurement locations or plural second measurement locations in a time resolved manner;
a processor configured to determine a distance between the optical measurement device (5) and at least one of the first locations or second measurement locations based on time-of-flight determination and/or frequency shift determination of the reflected laser beam versus the emitted laser beam, the processor being configured to determine a position of the measurement location based on the associated distance and angle setting of the deflector.

14. The arrangement according to claim 12, wherein the optical measurement device (140) comprises a laser device, in particular a light detection and ranging device (LIDAR).
